(19) United States
(12) Patent Application Publication
(10) Pub. No.: US 2016/0230041 A1
(43) Pub. Date: Aug. 11, 2016

(54) Transparent Structural Fortification Composite

(71) Applicant: Milspray LLC, Lakewood, NJ (US)

(72) Inventors: Matthew L. Johnston, Bayville, NJ (US); Jack Hayford, III, Brick, NJ (US)

(73) Assignee: Milspray LLC, Lakewood, NJ (US)

(21) Appl. No.: 15/019,639

(22) Filed: Feb. 9, 2016

Related U.S. Application Data
(60) Provisional application No. 62/114,532, filed on Feb. 10, 2015.

(51) Int. Cl. C09D 175/12; C09D 175/04

(52) U.S. Cl. CPC C09D 175/12; C09D 175/04

(57) ABSTRACT

A transparent polyaspartic polymer having elastomeric properties provides resistance to damage by environmental forces, visualization and enhanced tensile strength to a surface upon which the uncured polymer is applied. The polymer is particularly useful for visual inspection through the transparent cured polymer coating, and for protecting, concrete, stone and steel used in buildings, foundations, bridges and the like.

### RELATED APPLICATIONS

This application claims benefit to U.S. provisional application 62/114,532, filed Feb. 10, 2015, which, is incorporated herein by reference.

### FIELD OF THE INVENTION

This invention relates to a clear polymeric coating that can, be applied to elements of infrastructure substrate, such as building foundations made of steel, stone, concrete or other structural materials, and bridge structural elements made of concrete, steel, or other structural materials, to protect the surface of those substrates and to provide the ability to visually inspect the physical condition of the substrates.

### BACKGROUND OF THE INVENTION

Destructive forces are increasingly affecting the integrity of elements of civil engineered and architecural infrastructure, such as building foundations, bridge support columns, utility towers, culverts and the like. Damage and destruction from causes such as weather and its remediation, age, normal wear and tear, seismic events, malicious or military explosive detonations, and vehicle collisions can diminish the strength of such infrastructure elements. Degradation of weakened and deteriorating structures, especially those of cured solid construction material such as concrete and cement, is often manifest as spalling, in which surface cracks appear and propagate and the surface layers chip and flake off.

A traditional method of protecting, against deterioration is to coat the completed surface with a thin layer of a coating material. Conventional coating materials typically are opaque. Although the coating may be less than ten mils thick for paints and as much as 120 mils thick for polyurea coatings, rust, cracks and chips in the substrates cannot be observed by visual inspection because of coating opacity. Testing for structural defects thus requires application of expensive, technologically sophisiticated analytical instrumentation. A transparent protective coating applied to structural surfaces would reduce the need for such instrumentation by enabling visual inspection for for surface defects developing beneath the coating surface. The transparent polymer of the invention enables such visual inspection of the substrate surface.

Moreover, while concrete, as a construction material, has excellent compressive strength, tensile strength is low, which explains one reason concrete typically is reinforced. Reinforcement often is installed in cage-like arrangements to help compromised structures maintain more of their load bearing capacity than they would if the pieces of cracked concrete were to fall away from the structure.

The surface coating of the present invention supplements traditional concrete reinforcement by adding a small, yet helpful, enhancement to the tensile strength of the concrete. In addition, even when spalling and other deterioration occurs, a portion of the strength of the infrastructure element can be maintained if the compromised pieces of the structure remain a part of the structural unit. A resilient, high-tensile strength exterior coating can provide another element that increases the overall resistance of the structure to failure.

### SUMMARY OF THE INVENTION

Provided herein is a transparent polymeric composition that can be applied as a coating onto the surface of a substrate. The substrate may comprise or consist of metal, wood, stone, concrete or other structural materials utilized as supports for buildings, bridges, tunnels, piping (above or below grade), storage tanks, chemical emission stacks, material silos, dams, retaining walls, and the like. The clear coating can protect the substrate and its coated surface from environmental insult, including degradation from dirt, pollution and weather. The coating also possesses elastomeric properties that allow the coating to deform with the substrate structure. The coating therefore provides a resilient, high tensile strength reinforcement to substrates used in infrastructure elements, particularly those elements comprising concrete. Because the coating is clear, the coating features the ability to view surface defects in the underlying substrate to facilitate straightforward visual inspection.

### BRIEF DESCRIPTION OF THE DRAWINGS

FIG. 1 is a plot of stress versus strain data of samples made according to Example 1.

FIG. 2 is a plot of stress versus strain data of samples made according to Example 2.

FIG. 3. is a plot of stress versus strain data of samples made according to Example 3.

FIG. 4 is a plot of stress versus strain data of a fiber reinforced polyurea.

FIG. 5 is, a plot of stress versus strain data of a clear urethane.

FIG. 6 is a plot of load versus position for a three point flex test of an uncoated concrete sample.

FIG. 7 is a plot of load versus position for a three point flex test of a coated concrete sample.

FIG. 8 is a photograph of a coated concrete sample, which has a crack partially propagated through the sample.

### DETAILED DESCRIPTION OF THE INVENTION

As used herein, “transparent” or “clear” refers to the property of the composite or composition material wherein an object can be adequately visually viewed through the material for the purpose for which the viewing is intended. “Substrate” refers to any structural element, particularly an element that enables buildings and infrastructure to better withstand the forces that they were intended to withstand and resist. Such substrates especially include, although are not limited to, concrete, stone, steel, wood, plastic, glass, laminates and the like.

The polymer of the invention provides a visually transparent protective coating to new or existing structures that would benefit from the ability for persons, including those responsible for inspection of the structures, to visually observe or inspect the coated surface of the substrate of the structure through the clear polymer. As used within the scope of the present invention, the structure comprises a substrate to which the visually clear protective polymer is applied. The structure may include, but is not limited to, a building, a foundation, a road, a bridge, pipe, a utility tower, and the like, or the structure may comprise a part of an assembly for which a freely suspended or fastened amount of cured polymer is incorporated, such as used in place of window glass, as a structural component, or as a safety shroud around equipment that requires visual observation of a function of operation requiring protection for the observer from that function of operation.

The polymer described disclosed herein is a polyaspartic polymer containing urea groups (—NCON—) within some or all repeating units of the polymer chain. Esters, ethers, amides and urethanes also may be present in the polymer chain. The polyaspartic polymer is typically produced by reaction of a diisocyanate with an amine functional polyaspartic acid ester.

A preferred polyaspartic polymer composition for use according to the invention is formed by reacting aliphatic polyisocyanate resin, including 1,6-hexamethylene diisocyanate, with an amine functional polyaspartic acid ester and a polycarbonate diol. Preferred amine functional polyaspartic acid esters are selected from the DESMOPHEN® NH family of products (Covestro, North America, Pittsburgh, Pa.). These include DESMOPHEN NH 1220, 1420, 1520, and 1521. Representative 1,6-hexamethylene diisocyanate includes DESMODUR® N 3200, N 3300 and N 3900 (Covestro, North America, Pittsburgh, Pa.). Examples of polycarbinate diols include DESMOPHEN C XP 2613 and 2716 (Covestro, North America, Pittsburgh, Pa.). In addition, the use of polysiloxane resins and hybrids can be incorporated to enhance certain physical properties. A preferred polyaspartic polymer composition for use in this invention utilizes the formulations of isocyanate and polyol components of Table I.

TABLE I

| | Isocyanate | | Reactant |
|---|---|---|---|
| Isocyanate blend | Equivalent¹ | Nonisocyanate | Equivalent¹ |
| components | weight % | components | weight % |
| 1,6-hexamethylene | 100 | Amine functional | 75 |
| diisocyanate² | | aspartic acid | |
| | | ester³ | |
| | | Polycarbonate | 25 |
| | | Diol⁴ | |

¹= isocyanate to isocyanate-reactive material ratio = 1.09
²= Desmodur N3900
³= Desmophen NH 1420
⁴= Desmophen C XP 2716

As an aid to degassing the mixture, 0%-1.0% of a defoamer such as Byk 066N (Byk USA, Walingford, Conn.) may be added to the mixture. Additionally, 0%-3% acetone may be added to aid in degassing.

The preferred polyaspartic polymer was prepared as follows. All materials were maintained and mixed at about 70° F. The two non-isocyanate components, as well as any optional added defoamer and acetone, were mixed to form a homogenous blend. The isocyanate component was added to the container and agitation continued until a homogeneous mixture was achieved. The resulting mixture was degassed by placing in a vacuum chamber and vacuum was drawn to a pressure below 0.4 in Hg. Vacuum was maintained until essentially all entraped air had been removed from the mixture. This process also evaporated the majority of the acetone from the mixture. The uncured mixture in liquid form was coated onto the surface of a substrate. Coating can be accomplished by any conventional coating technique such as casting, pouring, brushing, transfer roll coating, spraying, doctoring and dip coating.

A preferred method of applying the polyaspartic acid polymer to a surface comprises the use of a plural component spray system, such as a Graco XP70 (Grace, Inc., Minneapolis, Minn.). Two-component spray applicators traditionally are used to apply two-component polyurethane foam or polyurea. Applying the present components to the use of two-component applicators, the homogenous blend comprising the non-isocyanate components is filled into one reservoir of the spray foam applicator system, while the isocyanate component is added to the second, separate reservoir of the system. The polymer is applied to a substrate by mixing the non-isocyanate component blend and the isocyanate component in the equipment mixing chamber just before application. In addition, a blocking agent, such as dimethylpyrazol (Wacker Chemie AG, Munich, Germany) can be used to inhibit the reaction between the isocyanate components and other reactive components, thereby allowing the mixture to be used as a single component coating. A single component coating can be sprayed with single component spray equipment, such as a Graco DH230 (Graco, Inc., Minneapolis, Minn.).

The polyaspartic polymer employed according to this invention provides exceptional clarity and also boosts the tensile performance of concrete, cement and stone to which it is applied.

In other preferred embodiments the polyaspartic polymer can be applied to fracturable substrates such as metal, wood, brick, masonry, concrete, cement, and glass. In such embodiment, the polymer system acts as an elastomeric polymer which envelopes the surface of the substrate. After fracture of such substrate due to earthquake, shock, impact, torsion, deterioration, friction, vibration, environmental degradation age and the like, the polyasrartic polymer can bind pieces of fractured surfaces to reduce crumbling and add structural reinforcement to a shattered structure of those fractured pieces. By holding pieces in place, the polyaspartic polymer can reduce dirt, dust and debris in the field near the site of fracture, and can provide additional residual strength to the structure.

This can be very helpful, for example, in the field of civil engineering where polymeric protection to concrete support structures for bridges and concrete building foundations is required. Commonly concrete structures are conventionally surveyed for damage by visual inspection. These structures are either uncoated or coated with conventional opaquely pigmented coatings. After fractures are detected, surface penetrating radar is used to further evaluate the nature of those fractures. Coating these structures with clear polyaspartic polymer according to this invention allows quicker surveying of these structures without resort to sophisticated, slow and expensive analytical instruments. Preferably, the thickness of the coating of polyaspartic polymer is substantially uniform over the surface area of the structure. The thickness should be at least about 10 mils, and preferably at least about 20 mils. The maximum thickness is usually determined by the cost of material utilized. The thickness should be at most about 500 mils, preferably at most about 400 mils, more preferably at most about 200 mils, and most preferably at most 150 mils.

### EXAMPLES

The preferred polyaspartic polymer was prepared as follows. All materials were maintained and mixed at about 70° F. The two non-isocyanate reactants, as well as any added defoamer and acetone, were mixed well to form a homogenous blend. The isocyanate component was added to the container and agitation continued until a homogeneous mixture was achieved. The resulting mixture was degassed in a vacuum chamber at a pressure below 0.4 in Hg. Vacuum was maintained until most entraped air had been removed from the mixture. This process also evaporated the majority of the acetone from the mixture. The uncured mixture in liquid form was coated onto the surface of a substrate and allowed to cure.

### Examples 1-3

Polyaspartic polymer compositions were prepared as described above using material compositions as formulated in Table II below. The compositions were formed into sheets from which samples were cut using ASTM standard D412 die C. The resulting samples were tested according to ASTM standard test D412. Results are described below and presented in Table II.

TABLE II

| | Example 1 | Example 2 | Example 3 |
|---|---|---|---|
| Sample Designation | AS3 | AS6 | AS8 |
| Desmodur-3900 e-wt %¹ | 100 | 100 | 100 |
| Desmophen NH 1420 e-wt % | 91 | 50 | 75 |
| Desmophen C XP 2716 e-wt % | 9 | 50 | 25 |
| Byk 066N p-wt. %² | 0.5 | 0.6 | 0.5 |
| Acetone p-wt % | 3.0 | 2.6 | 2.6 |
| Average Stress psi | 6804 | 2624 | 6337 |
| Average Axial strain % | 13.4 | 118.2 | 29.1 |
| Average Extention at | 5.5 | 118.2 | 6.2 |
| maximum load, % | | | |

¹equivalent weight %
²percent of total isocyanate and reactant mass

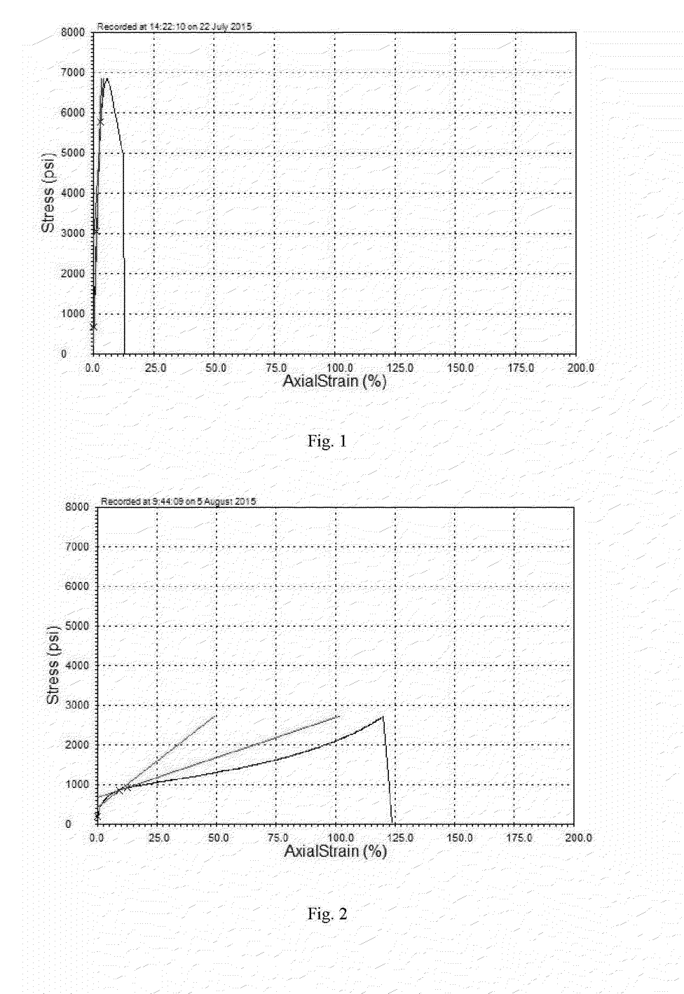

FIG. 1 provides stress versus strain data for the formulation of Example 1 that, at best, only marginally met the requirements of the desired coating. The curve shows the following characteristics relating to the desired characteristics of the polymer coating of Example 1.
1. The maximum strength of over 6000 psi is desirable within the aspect of the present invention. Concrete compressive strength commonly is 3000-6000 psi, but the tensile strength is only about 1/10^{th} of the compressive strength. The high tensile strength of the polymer enabled it to carry a significant tensile load to provide a strengthening effect for the concrete.
2. The steep initial slope reaching a maximum between 5.5% and 6.5% elongation shows that the material was able to help support tensile loads with little elongation. This is a desirable characteristic of the present invention, because the brittleness of a substrate such as cement, masonry or concrete requires rapid load support before the substrate fractures if any benefit from the tensile strength of the polymer is to be realized.
3. The elongation at failure of 13.4% was less than optimum for substrate reinforcement. An elongation of 30%±5% allows the polymer to provide resistance to crack propagation. As a crack propagates through the substrate the opening of the crack widens. The polymer can provide, additional strength to the substrate only as long as the polymer itself has not fractured. Too little elongation results in polymer fracture and loss of the support provided by the polymer.

FIG. 2 provides stress versus strain data for the formulation of Example 2 that did not meet the requirements of the desired coating. The curve shows the following characteristics relating to the undesirable characteristics of the polymer coating of Example 2.

The demonstrated maximum strength of only 2600 psi is insufficient carry a significant tensile, load prior to failing.
1. The polymer did not reach maximum strength until well beyond 100% elongation. A more desireable maximum strength should be realized within 15% of achievable elongation.
2. Polymer 2 realized only a small fraction of its available strength prior to complete fracturing of the substrate. As such, the concrete specimen, had wholely fractured through the entire sample thickness prior to the capacity of the polymer to provide desirable structural support.
3. The elongation at failure of 118% was achieved at the cost of low tensile strength and low initial strength development. High elongation is beneficial only if both initial and overall tensile strength are sufficiently providing resistance to substrate fracturing, or resistance to fracture progression deeper within the substrate.

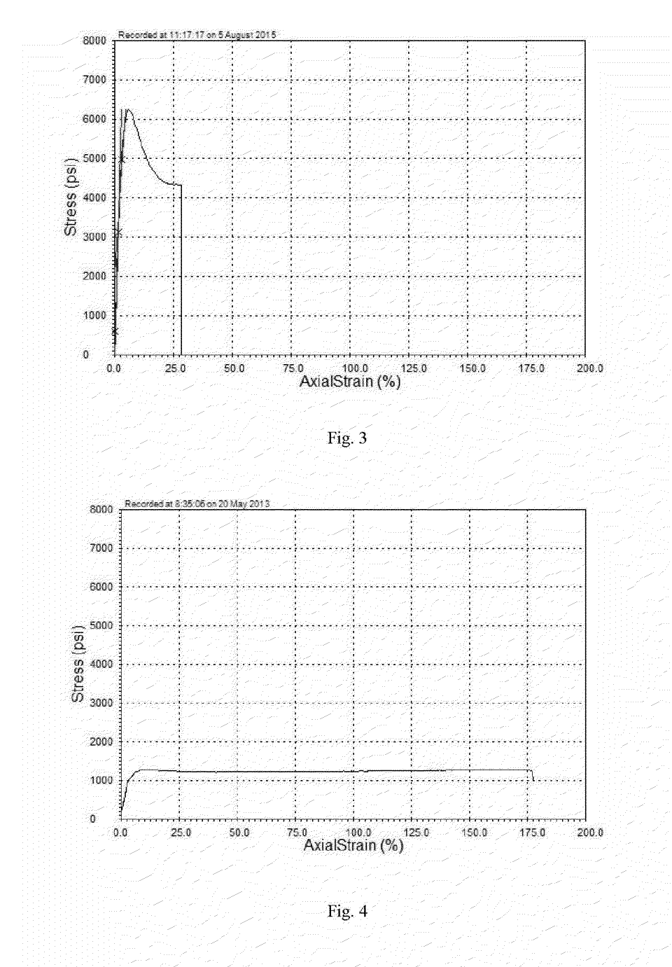

FIG. 3 provides stress versus strain data for the formulation of Example 3 that optimally balanced all the requirements of the desired coating. The curve shows the following characteristics relating to the desired characteristics of the polymer coating.
1. Similar to Example 1, the maximum strength over 6000 psi is a desirable characteristic according to the invention.
2. The steep initial slope reaching a maximum of between 5.5% and 6.5% elongation shows that the polymer of Example 3 provides tensile load support to the substrate while exhibiting very little elongation. This is an important attribute to the invention, because the polymer contemplated by the invention should exhibit early strength development to avoid substrate fracture prior to receiving reinforcement from the polymer coating. Therefore, when combined as a system with the substrate, the polymer provides deformation resistance beyond the capabilities of the substrate itself
3. The elongation at failure of almost 30% is more desirable than the elongation percentages otherwise identified, such that, at about 30%, the polymer provides supplemental substrate reinforcement during crack propagation through the substrate. The polymer of Example 3 exhibited additional strength properties beyond the inherent properties of the substrate itself, such that as the substrate failed to withstand resistance to deformation, the polymer provided residual resistance to such deformation and provided support to the substrate throughout substrate crack propagation.

FIG. 4 provides stress versus strain data for a fiber added polyurea, which is a traditional concrete reinforcement coating material. Like the invented polymer, the fiber reinforced polyurea exhibited rapid strength development that is seen in many fiber reinforced polymers. However, the maximum strength of this polyurea was inadequate. More importantly, this polyurea was not transparent, which is an advantageous feature of the invented polymer. Even if the polymer constituents of the polyurea matrix were able to be manufactured with optical clarity, the presence of the imbedded fibers would substantially diminish with the clarity of the coating, thus inhibiting substate visualization through the resultant coating.

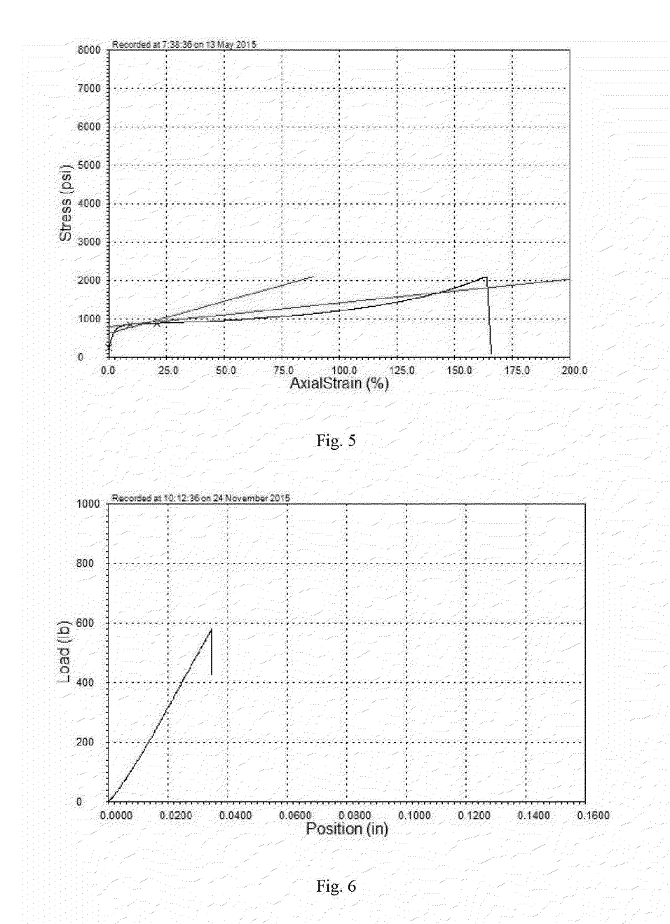

FIG. 5 provides stress versus strain data for an optically clear urethane based polymer. This polymer provided the necessary optical clarity for easy visual inspection like the inventive polymer. The graph denotes a deficiency of the ability of the polymer to provide desirable tensile strength. Furthermore, neither the lack of early onset of tensile strength development nor the total strength were sufficient to provide the desired tensile strength support properties that is desireable for a polymer of the invention.

FIG. 6 shows the load versus deflection curve for a three point flex test of an uncoated concrete sample. The graph represents a normal increase of substrate deflection coupled with the increasing load, to which a peak is formed within the graph that represents the complete failure of the substrate to maintain structural integrity. Thus FIG. 6 demonstates complete substrate failure and breakage. The shape of this graph is typical of such failure, so may be considered to represent sudden and complete failure by fracture of a common concrete structure due to increasing pressure on the structure.

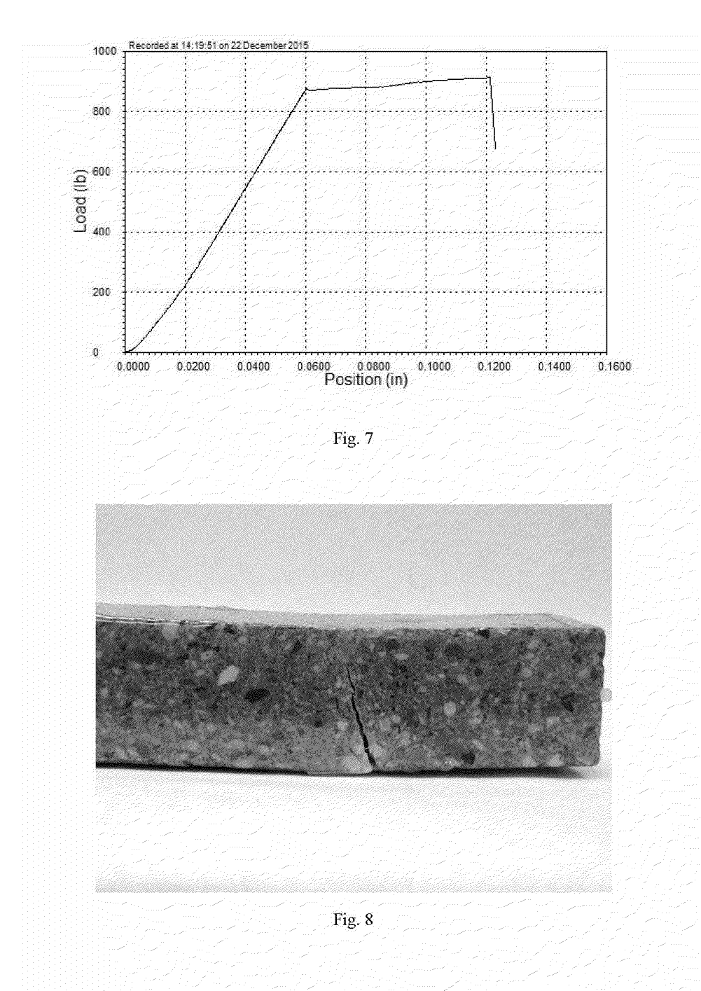

FIG. 7 shows the load versus deflection curve for a three point flex test of a common concrete structure of FIG. 6 with, addition of the polymer applied to its exterior surface. The point at which the plotted line substantially changes its slope is the point at which the sample began to crack. Three points distinguish the coated sample shown in the present graph from an uncoated sample:
1. The sample began to crack at a higher load than the uncoated sample, demonstrating that the coating increased the tensile strength.
2. The sample began cracking at greater deflection than the uncoated sample, demonstrating that the increase in tensile strength allowed greater deformation prior to crack initiation.
3. The sample exhibited a deflection plateau from the point at which cracking began to the break point. This demonstrates that the coating provides support to the sample so that crack propagation is gradual rather than catestrophic. In other words, the crack propagated more slowly and maintained a load over a larger deflection.

FIG. 8 is a photograph of a coated concrete sample having a crack partially propagated through the sample.

Although specific forms of the invention have been selected in the preceding disclosure for illustration in specific terms for the purpose of describing these forms of the invention fully and amply for one of average skill in the pertinent art, it should be understood that various substitutions and modifications which bring about substantially equivalent or superior results and/or performance are deemed to be within the scope of the following claims.

1. A coated substrate comprising a transparent polyaspartic coating that covers, and is in direct contact with, at least a portion of a surface of the substrate, and that increases the tensile strength of the portion of the substrate surface to which the polymer is applied.

2. The coated substrate of claim 1, wherein the transparent coating is of substantially uniform thickness of about 10 mils to about 500 mils.

3. The coated substrate of claim 1, wherein the transparent coating is of substantially uniform thickness of about 20 mils to about 200 mils.

4. The coated substrate of claim 1, wherein the transparent coating is of substantially uniform thickness of about 20 mils to about 150 mils.

5. The coated substrate of claim 1, wherein the polyaspartic coating is replaced by a transparent urethane, polymer coating.

6. The coated substrate of claim 5, wherein the transparent coating is of substantially uniform thickness of about 10 mils to about 500 mils.

7. The coated substrate of claim 5, wherein the transparent coating is of substantially uniform thickness of about 20 mils to about 200 mils.

8. The coated substrate of claim 5, wherein the transparent coating is of substantially uniform thickness of about 20 mils to about 150 mils.

9. A transparent polyaspartic coating made from a composition comprising 1,6-hexamethylene diisocyanate and a mixture comprising an amine functional aspartic acid ester and a polycarbonate diol.

10. The polyaspartic coating of claim 9, wherein the composition has an isocyanate to isocyanate reactive ratio of 1.0 to 1.2 for the 1,6-hexamethylene diisocyanate and the mixture, wherein the mixture comprises about 75 wt % of the amine functional aspartic acid ester and about 25 wt % of the polycarbonate diol.

11. The polyaspartic coating of claim 9, which when applied to at least a portion of a surface of a substrate increases the tensile strength of the substrate and allows visualization of the surface through the polymerized coating.

12. A method for visualizing and increasing the tensile strength of a surface of a substrate comprising
a. Mixing an amine functional aspartic acid ester, a polycarbonate diol and, optionally, 0 wt % to 0.1 wt % defoamer and, optionally, 0 wt % to 3 wt % acetone to homogeneity.
b. Adding an isocyanate blend to the mixture of step a and mixing to homogeneity.
c. Degassing the mixture of step b in a vacuum chamber at pressure below 0.4 in Hg until essentially all volatile components and entrapped air are removed from the mixture.
d. Coating onto, or forming into, the surface of the substrate the uncured liquid mixture and allowing the mixture to cure.

13. The method of claim 12, wherein the isocyanate blend is 1,6-hexamethylene diisocyanate.

14. The method of claim 12, wherein the isocyanate blend is Desmodur N3900, the amine functional aspartic acid ester is Desmophen NH 1420 and the polycarbonate diol is Desmophen C XP 2716.

15. The method of claim 12, wherein the method is, performed at about 70° F.

16. The method of claim 12, wherein the isocyanate blend of step b comprises Desmodur N3900 that is mixed at an isocyanate to isocyanate-reactive ratio of 1.0 to 1.2 with the mixture of step a comprising about 75 wt % of Desmophen NH 1420 and about 25 wt % of Desmophen C XP 2716.

17. The method of claim 12, comprising
a. Filling the mixture of step a and the mixture of step b separately as the respective two components of a two-component sprayer or two-component spray system;
b. Coating the resulting mixture onto the substrate surface according to step d using the two component sprayer.

18. The method of claim 17, wherein the isocyanate blend is 1,6-hexamethylene diisocyanate.

19. The method of claim 17, wherein the isocyanate blend is Desmodur N3900, the amine functional aspartic acid ester is Desmophen NH 1420 and the polycarbonate diol is Desmophen C XP 2716.

20. The method of claim 17, wherein the method is performed at about 70° F.
